(19) United States
(12) Patent Application Publication
(10) Pub. No.: US 2002/0064981 A1
(43) Pub. Date: May 30, 2002

(54) Electric appliance for protecting power input element

(76) Inventors: Wen-Lung Yu, Taoyuan Hsien (TW); Yung-Cheng Chang, Taoyuan Hsien (TW)

Correspondence Address: BEVER HOFFMAN & HARMS, LLP, 2099 GATEWAY PLACE, SUITE 320, SAN JOSE, CA, 951101017

(21) Appl. No.: 09/801,008

(22) Filed: Mar. 6, 2001

(30) Foreign Application Priority Data
Nov. 30, 2000 (TW) 89220837

(51) Int. Cl. H01R 13/44

(52) U.S. Cl. 439/135

(57) ABSTRACT

An electric appliance for providing a closed space to protect a power input element thereof is disclosed. The electric appliance includes an electronic module, an isolation device integrally formed with the electronic module for mounting the power input element therein, and an open-shut device moveably connected to the isolation device for opening and shutting the isolation device, thereby providing the closed space to protect the power input element form the external damage.

### FIELD OF THE INVENTION

The present invention relates to an electric appliance, and more particularly to an electric appliance for protecting a power input element form the external damage.

### BACKGROUND OF THE INVENTION

Most industrial accidents are occurred because the sockets of the electric appliances are exposed to extreme environment, such as high humidity, high temperature and acidic vapor. Furthermore, the electroplates of the plugs are easily stripped so as to increase the resistance and the current flowing through the circuit. Therefore, the temperature of the machine tool would be excessively high, and further the industrial accidents such as an accidental discharge and an explosion are generated and the casualty for the workers are happened. In addition, the transfer quality of the communication station would be affected under the condition that the socket of the power supply is exposed to extreme environment.

It is therefore tried by the applicant to deal with the above situation encountered by the prior art.

### SUMMARY OF THE INVENTION

It is therefore an object of the present invention to provide an electric appliance for providing a closed space to protect a power input element thereof from the external damage.

It is another object of the present invention to provide an electric appliance in which a power input element thereof can be mounted in an isolation device.

It is another object of the present invention to provide an electric appliance for avoiding the damage ratio of a power input element to maintain the communication transfer quality.

It is another object of the present invention to provide an electric appliance for reducing the industrial accidents.

According to an aspect of the present invention, the electric appliance for providing a closed space to protect a power input element thereof includes an electronic module, an isolation device integrally formed with the electronic module for mounting the power input element therein, and an open-shut device moveably connected to the isolation device for opening and shutting the isolation device, thereby providing the closed space to protect the power input element form the external damage.

The power input element is preferably a socket.

Preferably, the isolation device includes a first clipping element and the open-shut device includes a second clipping element corresponding to the first clipping element for tightly clipping an external power cord.

Preferably, each of the first clipping and second clipping elements is formed of a rubber pad.

Preferably, the closed space is formed to be electrically connected to the power input element when the openshut device is shut.

Preferably, the present invention further includes a fastening element for tightly securing the open-shut device to the isolation device when the open-shut device is shut.

The fastening element is preferably a screw.

Preferably, the open-shut device is pivotally connected to the isolation device.

According to another aspect of the present invention, the electric appliance for providing a closed space to protect a power input element thereof, includes an electronic module, an isolation device connected to the electronic module for mounting the power input element therein, and an open-shut device moveably connected to the isolation device for opening and shutting the isolation device, thereby providing the closed space to protect the power input element form the external damage.

Preferably, the isolation device is connected to the electronic module by screwing.

The present invention may best be understood through the following descriptions with reference to the accompanying drawings, in which:

### BRIEF DESCRIPTION OF THE DRAWINGS

FIG. 1(a) is a schematic view showing an electric appliance for protecting a power input element according to a preferred embodiment of the present invention, wherein an isolation device is open; and

FIG. 1(b) is schematic view showing an electric appliance for protecting the power input element according to the preferred embodiment of the present invention, wherein the isolation device is shut.

### DETAILED DESCRIPTION OF THE PREFERRED EMBODIMENTS

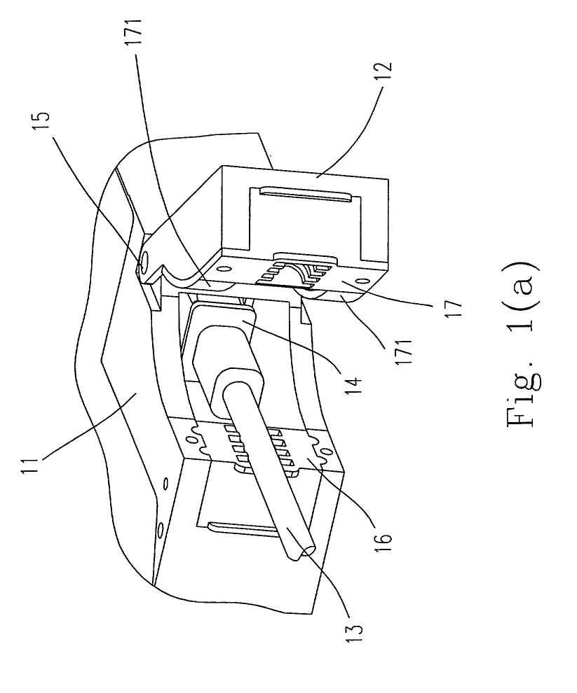

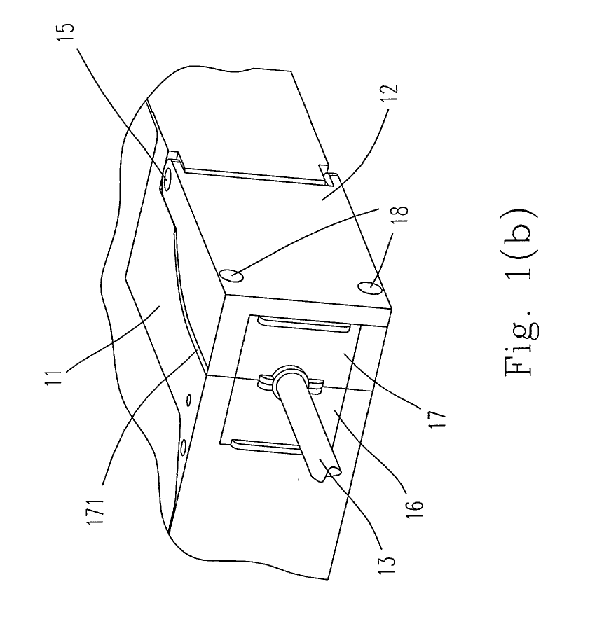

FIGS. 1(a) and 1(b) show the schematic views of an electric appliance for protecting a power input element according to a preferred embodiment of the present invention, wherein an isolation device is respectively open and shut are shown. The electric appliance includes an electronic module (not shown), an isolation device 11 and an open-shut device 12. A closed space is formed between the isolation device 11 and the open-shut device 12, thereby protecting a power input element 14 of the electronic module form the external damage. The power input element 14 is preferably a socket. As for the electronic module, which is an electric appliance having a power input element and preferably is a power supply adapted to be used in communication apparatuses.

The isolation device 11 is used to mount the power input element 14. The isolation device 11 would be one portion of the electronic module and integrally formed with the electronic module. On the other hand, the isolation device 11 and the electronic module would be detachable respectively and the isolation device 11 is connected to the electronic module by a fastening element 18. Generally, the fastening element 18 is a screw. Moreover, the isolation device 11 includes a first clipping element 16. The open-shut device 12 is employed to open and shut the isolation device 11 by rotating a pivot 15. The open-shut device 12 includes a second clipping element 17 connected to a rubber pad 171 mounted around, thereby tightly securing the open-shut device 12 to the isolation device 11 when the open-shut device 12 is shut, as shown in FIG. 1(a)

When the open-shut device 12 is shut, a power cord 13 is clipped and clenched by the first clipping element 16 and the second clipping element 17. In addition, each of the location of the first clipping element 16 and the second clipping element 17 to clench the power cord 13 is in a shape of semicircular, which facilitates preventing water from invading the power input element 14. Furthermore, the fastening element 18 is used to tightly secure the open-shut device 12 to the isolation device 11 when the open-shut device 12 is shut, as shown in FIG. 1(b). Preferably, the fastening element 18 is a screw and each of the first clipping element 16 and the second clipping element 17 is formed of a rubber pad.

It is understood that the conventional external damage of the power input element could be effectively avoided according to the present invention. The present invention also provides a safety environment for isolating the power input element and reducing the industrial accidents.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

1. An electric appliance for providing a closed space to protect a power input element thereof, comprising:
an electronic module;
an isolation device integrally formed with said electronic module for mounting said power input element therein; and
an open-shut device moveably connected to said isolation device for opening and shutting said isolation device, thereby providing said closed space to protect said power input element form the external damage.

2. The electric appliance according to claim 1, wherein said power input element is a socket.

3. The electric appliance according to claim 1, wherein said isolation device comprises a first clipping element.

4. The electric appliance according to claim 3, wherein said open-shut device comprises a second clipping element corresponding to said first clipping element for tightly clipping an external power cord.

5. The electric appliance according to claims 4, wherein each of said first clipping and second clipping elements is formed of a rubber pad.

6. The electric appliance according to claim 1, wherein said closed space is formed to be electrically connected to said power input element when said open-shut device is shut.

7. The electric appliance according to claim 1, further comprising a fastening element for tightly securing said open-shut device to said isolation device when said open-shut device is shut.

8. The electric appliance according to claim 7, wherein said fastening element is a screw.

9. The electric appliance according to claim 1, wherein said open-shut device is pivotally connected to said isolation device.

10. An electric appliance for providing a closed space to protect a power input element thereof, comprising:
an electronic module;
an isolation device connected to said electronic module for mounting said power input element therein; and
an open-shut device moveably connected to said isolation device for opening and shutting said isolation device, thereby providing said closed space to protect said power input element form the external damage.

11. The electric appliance according to claim 10, wherein said isolation device is connected to said electronic module by screwing.
